(19) United States
(12) Patent Application Publication
(10) Pub. No.: US 2019/0242785 A1
(43) Pub. Date: Aug. 8, 2019

(54) Method for Configuring and Monitoring an Installation

(71) Applicant: Robert Bosch GmbH, Stuttgart (DE)

(72) Inventors: Thomas Inderwies, Frammersbach (DE); Adrien Mouaffo Tiadjio, Gerlingen (DE); Christoph Maier, Kleinostheim (DE); Jochen Mueller, Backnang (DE); Patric Brand, Sennfeld (DE); Peter Rehbein, Erlabrunn (DE); Roman Ritter, Stuttgart (DE); Sebastian Vornwald, Wuerzburg (DE); Wolfgang Rueppel, Frammersbach (DE)

(21) Appl. No.: 16/264,325

(22) Filed: Jan. 31, 2019

(30) Foreign Application Priority Data
Feb. 6, 2018 (DE) 10 2018 201 838.3

(51) Int. Cl. G01M 13/00

(52) U.S. Cl. CPC G01M 13/00

(57) ABSTRACT

A method for monitoring an installation having at least one component includes providing a data set including a plurality of possible installation types, and detecting a plurality of measurement variables. Each of the measurement variables is respectively associated with at least one of the components of the installation. The method further includes determining the installation type of the monitored installation by comparing the detected measurement variables with the plurality of possible installation types in the data set. The method also includes determining a state of at least one of the components of the installation depending on the detected measurement variables and the determined installation type.

This application claims priority under 35 U.S.C. § 119 to patent application no. DE 10 2018 201 838.3, filed on Feb. 6, 2018 in Germany, the disclosure of which is incorporated herein by reference in its entirety.

### BACKGROUND

The disclosure relates to a method for monitoring an installation and to a method for monitoring an installation, in particular a production installation or a machine tool.

In order to monitor installations, it may be necessary to have precise knowledge about the installation to be monitored, in particular about the installed components and sensors. If a monitoring system is attached to an installation, this requires precise configuration of the monitoring system. This may be complicated and susceptible to errors, in particular with respect to inputs to be undertaken manually.

### SUMMARY

Proceeding from this, it is an object of the disclosure here to solve or at least alleviate the technical problems mentioned in connection with the prior art. In particular, the intention is to present a method for monitoring an installation by way of which particularly simple and reliable monitoring is possible.

Said object is achieved by way of a method for monitoring an installation and by way of a method for configuring and monitoring an installation according to the features disclosed herein. The features presented individually in the patent claims can be combined with one another in any desired, technologically expedient manner and can be supplemented by explanatory substantive matter from the description, wherein further embodiment variants of the disclosure are demonstrated.

This is addressed by a method for monitoring an installation having at least one component, said method comprising at least the following steps:

a) providing a data set, which comprises a plurality of possible installation types,
b) detecting a plurality of measurement variables, wherein each of the measurement variables is respectively associated with at least one of the components of the installation,
c) determining the installation type of the monitored installation by comparing the measurement variables detected according to step b) with the plurality of possible installation types in the data set provided according to step a), and
d) determining a state of at least one of the components of the installation depending on the measurement variables detected according to step b) and the installation type determined according to step c).

The described method is suitable, in particular, for monitoring installations such as, for example, production installations (for example rolling mills or wind power installations), machine tools (for example injection molding machines) or vehicles (for example construction machines such as excavators or the like, which comprise, in particular, a hydraulically operable component).

The installation may be mobile or stationary. “Monitoring” can be understood to mean that a (current) state of the installation and/or the components thereof are detected. For example, it is possible to identify which components of the installation are or were subjected to what extent of loading, with the result that it is possible to infer wear phenomena. By way of the described method, it is possible, in particular, to obtain knowledge about which component of the installation has to be exchanged or repaired at which time. The monitoring can include the obtaining of the knowledge of the state of the installation, in particular with respect to the question of whether and to what extent faults have arisen and/or to what extent components of the installation were subjected to loading (possibly also to overloading). Furthermore, the monitoring can also include reacting to such knowledge, for example by virtue of the installation being turned off in a situation identified as critical.

The components of the installation are constituent parts from which the installation is composed. The components can be used repeatedly for the operation of the installation or can predetermine operation thereof. The components can be embodied with operating means (for example fluids) and/or wear parts (for example seals, buttons, etc.). For example, the following are considered as components: a motor, a valve, a (fluid) line, an operator control element, a control electronics system, a hydraulic drive or a wheel of a vehicle.

The installation can be monitored, in particular, by measuring parameters of the operation of the installation. In this case, sensors, which are connected to a data network (preferably by way of a radio connection), can be provided on the installation. The sensors and the data network can in this case be designed so that they can be used for a multiplicity of different installations. The data network is preferably designed as a data cloud. The sensors can be provided, in particular, in sensor units, which are of autonomous design and which for this purpose have, in particular, a battery and can communicate with the data network by means of a radio connection. Such sensor units can in each case comprise, for example, a temperature sensor, an acceleration sensor, a light intensity sensor and/or a magnetic field sensor. Depending on requirements, it is possible to activate one or more of the sensors of a sensor unit so that the sensor unit transmits the corresponding measurement values to the data network.

In various installations, the sensor units can be used to capture a wide variety of parameters. Therefore, using a particular one of the sensor units, for example in an excavator, the motor temperature can be measured, while the same sensor unit (or a sensor unit with the same ID) is used in a production installation, for example, to measure a hydraulic pressure. For the correct monitoring of the installation, specifications about which sensor unit at which point of the installation captures which measurement variables are therefore necessary. Such specifications are intended to be included here by the specification of the installation type. The installation type comprises, in particular, for each sensor unit to be used, a specification about the point at which said sensor unit is provided on the installation and which measurement variable is to be captured. This means that installations of the same installation type are designed to be identical at least to the extent that the same measurement variables are captured using the individual sensor units in the various installations and that the measurement variables in the various installations have the same meaning. For example, two excavators are thus of the same installation type when a motor temperature is captured using a first of two sensor units (which has, for example, an ID “No. 1”) and a hydraulic pressure at a specific hydraulic cylinder is measured using a second of the two sensor units (which has, for example, an ID “No. 2”). Moreover, it is not necessary for the two excavators to be constructed or designed in an identical manner. An excavator and a production installation are, in contrast, different installation types. Two excavators are also of a different installation type when a motor temperature is captured using the first sensor unit in one of the excavators while a hydraulic pressure is measured using the first sensor unit in a second—otherwise identically designed—excavator.

The installation type can influence the loading of the components (and hence, for example, the typical service life for individual components, component part temperatures and/or vibration loadings). For each individual installation type, it is possible to determine limits for such parameters, at which limits a reaction is to be triggered. There can thus be different limits for components, in particular depending on whether these are provided, for example, in a turning lathe, in a compactor or in a plastic injection molding machine.

By way of the installation type, it is also possible, for example, to differentiate between machines such as an excavator, a tractor, a road roller, a turning machine, a compactor or an injection molding machine. An installation type may be a sub-function of an installation (for example excavator arm).

If installations of the same installation type are compared, for example also on a machine, these are each of identical design, for example two arm segments and a hydraulic cylinder. The sensors also determine the same physical variables, that is to say, for example, sensor 1 always measures the temperature at the hydraulic cylinder 1).

In the case of a specific installation type, the position and configuration of the sensor can thus also always be predetermined.

When the installation is monitored, it is possible to resort to the specifications about which sensor unit captures which measurement variable. These specifications are included in the installation type. If the installation type is known, the measurement variables can therefore be correctly associated with the components of the installation. The installation type could, for example, be input into an input element manually by a user. However, this is susceptible to errors. Using steps a) to c) of the described method, the installation type of the present installation can instead be identified in an automated manner. This can facilitate the performance of the method and, in particular, contribute to preventing input errors.

In particular, to identify the installation type, in step a), a data set is provided, which comprises at least a plurality of possible installation types. In this case, any installation type that can be identified according to the present method is intended to be regarded as a possible installation type. The possible installation types (or the parameters of the installation type that are to be checked) may have been stored in the data set before the performance of the method for this purpose (in particular once) so that, when the described method is performed, any installation type from the data set can be identified as a possible installation type. “Providing” includes an existing (and previously obtained) data set being used and/or the data set being compiled as part of the described method. The data set can be provided, in particular, in a data network that is intended and configured to perform the described method.

In step b) of the described method, a plurality of measurement variables are detected. This can be carried out, in particular, using the described sensor units. Each of the measurement variables is preferably associated with a component of the installation. As an alternative, a measurement variable can also be associated with a plurality of components of the installation. Preferably, at least one measurement variable is not associated with all the components and therefore with the installation as a whole. This makes it possible to be able to differentiate between the individual components. The fact that the measurement variable is associated with at least one component means that the measurement variable specifies a property of the corresponding at least one component. It is thus possible, for example, for a temperature measured at a housing of a motor to be regarded as the motor temperature and therefore as associated with the motor as a component. An association in this context is present when the measurement variable is suitable for being able to make a statement about the state of the component. It is thus possible to infer from the motor temperature, for example, whether the motor is operating and/or whether there is a fault (for example overheating).

The measurement variables detected in step b) are preferably provided with a timestamp. When evaluating the measurement variables, the time of the measurement can be taken into account or tracked in a particularly accurate manner. As an alternative, an input time could also be allocated to the measurement variables as a measurement time. In this case, however, different propagation times can result in inaccuracies. The detected measurement variables are preferably transmitted to a data network and processed there.

In step c) of the described method, the installation type of the monitored installation is determined. This is carried out, in particular, based on the measurement variables detected according to step b). In this case, it can be assumed, in particular, that a specific measurement variable during operation of an installation of a specific installation type will always lie within a respective value range and/or will have a specific time profile. Therefore, for example, a time profile of an unknown measurement variable can be compared with various time profiles of (stored) measurement variable profiles, said time profiles being stored in the data set. If, in this case, a time profile having identical features or features that are similar at least in the context of predefinable tolerances is identified, this is indicative of the fact that the present installation is of the installation type for which the corresponding time profile is stored in the data set.

The measurement variables can be compared with the data set, in particular, independently of units of measurement. Therefore, for example, a time profile of an electrical voltage signal can be used without knowledge of whether this voltage signal has been generated, for example, by a temperature sensor or by a light intensity sensor being necessary. The time profile can be scaled and compared with—correspondingly scaled—time profiles from the data set.

It is possible that the kind of parameters involved is taken into account during comparison of the measurement variables with the time profiles stored in the data set. Therefore, the comparison can be reduced, for example, to time profiles of measured temperatures being compared only with temporal temperature profiles from the data set. In this case, any desired scaling can be used. Where appropriate, alternatively or cumulatively absolute values can be compared.

After the installation type has been determined in step c), the measurement variables detected according to step b) can be interpreted correctly. Therefore, given knowledge of the installation type, a voltage applied to an input channel can be converted to the measurement variable provided at said input channel in the specific installation type.

In step d) of the described method, the state of at least one component of the installation is determined. The measurement variables detected according to step b) that can be correctly interpreted through knowledge of the present installation type can be used here. In step d), exceedance of limit values can be detected, for example. Therefore, the state of a motor may be, for example, “fault-free” if the motor temperature is below a limit value while the state is otherwise “overheated”.

The state can include an operating time. Therefore, in the case of a motor, the operating time can be defined as the period in which the motor temperature is above a limit (different from the limit discussed above).

In the case of a valve, actuation of the valve can be identified, for example, by measuring accelerations. With each actuation, an actuation counter can be raised by the value “1”.

In a preferred embodiment of the method, in step b), at least one superordinate, in particular component-unspecific, measurement variable is detected, which is associated overall with at least one part of the installation. In addition to the measurement variables associated with one individual or several of the components, in the present embodiment, measurement variables associated with the installation overall can also be used. For example, a temperature (for example an ambient temperature at a location not heated/cooled by the installation), an acceleration, a magnetic field (of the earth) (for example also a magnetic influence of a secondary or further installation), a service life and/or a number of actuations can be considered as such a “superordinate” measurement variable. Variables can also be considered as a function of one another. Therefore, for example, a service life within a specific temperature range can be used as a measurement variable. By way of at least one of these measures, an “offset” (constant component) of the measurement values can be determined (computationally).

In a further embodiment of the method, in step c), correlations between a plurality of the measurement variables detected according to step b) are determined and compared with correlations of said measurement variables stored in the data set for various installation types.

Considered as a correlation of a measurement variable with one or more other measurement variables is each dependency between said variables. In particular, a correlation can be expressed as a mathematical function. A correlation can also include, in particular, the time as a parameter. Therefore, a dependency between measurement variables for various times may be different. In such a case, a correlation can include dependencies at different times and/or over one or more periods of time.

An example of a correlation is a motor temperature that increases with a time delay with respect to a beginning of a vibration measured at the motor. This correlation can therefore result, in particular, because the motor begins to vibrate when turned on and reaches its operating temperature after a warmup period.

By using correlations between a plurality of (different and/or temporally offset) measurement variables, the installation type can be determined in a particularly reliable manner. If it is determined in the present installation, for example, that a first measurement variable increases with a time delay with respect to the beginning of an increase of a second measurement variable, this can be an indicator for the first measurement variable being a motor temperature and the second measurement variable being a vibration measured at the motor. The installation type can accordingly be inferred, wherein a motor temperature is measured as the first measurement variable and a vibration at the motor is measured as the second measurement variable. In order to be able to make a distinction between a multiplicity of installation types, it is preferred to consider more than one correlation between measurement variables.

In a further embodiment of the method, the data set in step a) is provided with a neural network way of learning in such a way that values of the measurement variables to be detected according to step b) for the plurality of installation types contained in the data set are processed using the neural network.

The neural network can be used, in particular, once before performance of the described method. Correlations between measurement variables can be detected particularly well using a neural network, in particular even when a theoretical basis for the correlation is not known. In order to determine the correlations present in a specific installation type, values for the individual measurement variables occurring in this installation type can be fed to the neural network. The values can be obtained, for example, through simulation.

The providing in step a) can include both the use of a previously obtained data set and the compilation of the data set as part of the described method.

As an alternative or in addition, the values can be obtained through measurement. In particular, the embodiment of the method in which the values processed by the neural network are obtained through measurement of the corresponding measurement variables at a plurality of possible installations to be monitored with a known installation type is preferred for this.

In this embodiment, each possible installation type can be measured, for example once before performance of the described method (or alternatively as part of step a)), in such a way that the values occurring over time of the measurement variables are determined. In this case, various operating modes can also be taken into account.

In particular, in this embodiment, data can be detected by sensor units, which are connected in a mechanically fixed manner to the components of the installation, and also optionally by further sensors, which are associated with the installation overall. The measurement variables are preferably provided with a respective timestamp and transmitted to the data network. In addition, for example, a technical description of the components and/or the installation is preferably available to the data network. The data network therefore receives two data packets, which are associated with an installation type. By way of the capture, transmission, analysis, consolidation (in particular using means of “machine learning”) of many data cycles, a particularly precise sensor image (that is to say a sensor data pattern) of an installation type can be generated and continuously improved.

In a further embodiment of the method, the state determined in step d) includes at least one state of wear of the respective component of the installation. The state of wear of a component can include, in particular, all properties of the component in which a deterioration, which can impair the operation of the component, occurs during operation over time.

In particular, in the present embodiment, the described method can also be referred to as “condition monitoring” and/or “predictive maintenance”. “Condition monitoring” can be understood as meaning that the state of the components of the installation is monitored continuously or at least regularly and that wear of the component is thus not initially identified by a fault. “Predictive maintenance” can be understood as meaning that maintenance work is planned in advance by virtue of a prediction being made based on a current state of a component of the installation as to when a replacement or a repair of the component will likely be necessary. In this case, recourse can be made, in particular, to empirical values.

If the installation type is not known, this can be identified by comparing the detected measurement variables with the data set in the data network. The correct decision with respect to “condition monitoring” and/or “predictive maintenance” adjusted to different installation types can thus be facilitated, improved and automated.

For example, “condition monitoring” can be used in hydraulic valves, which are used, for example, in process-relevant functions in steel plants. Such hydraulic valves are usually subjected to particularly severe wearing due to the high loading (which can result, in particular, through cavitation and/or contaminated oil). Downtimes of approximately one year are usual. By evaluating data of the “condition monitoring” aligned with empirical values of identical installations (in particular by accessing cloud data), a “time of failure” can be predicted. Therefore, unplanned failures can be reduced and operating times of the components can be optimized.

In a further embodiment, the method additionally comprises at least the following method step:

e) adjusting at least one operating parameter of the installation depending on the state determined according to step d).

Using step e) of the described method, it is possible to react to the determined state. To this end, at least one operating parameter can be changed. Any variable which can be used to actively influence or control the operation of the installation is considered as an operating parameter. If it is identified, for example, that a specific component of the installation is worn to a particularly severe extent, the installation can—if possible—be repositioned in such a way that loading of said component is reduced. If the wear of a component is pronounced in such a way that there is a threat of damage to the installation or the surroundings thereof, the installation can be completely or partly turned off.

In particular, in the present embodiment, the described method can also be referred to as “predictive maintenance”. In particular, the operation of installation in the present embodiment can be optimized in such a way that wear of components has the lowest possible influence (“machine optimization”).

As a further aspect, a method for configuring and monitoring an installation is presented, which comprises at least the following method steps:

A) providing the installation,
B) attaching a plurality of sensor units to the installation, wherein at least one respective measurement variable can be detected using the sensor units,
C) monitoring the installation using a method, as described herein, using the sensor units attached according to step B).

The particular advantages and refinement features described for the described method of monitoring the installation can be applied and transferred to the described method for configuring and monitoring the installation, and vice versa.

In step A), providing the installation is to be understood to mean both the use of a previously produced installation and the production of a new installation. The installation in step A) be provided, in particular, without sensors intended for use in step C). The sensors are provided in step B) by the sensor units. This means, in particular, that an existing installation can be configured for monitoring according to step C) using steps A) and B). Step B) can be regarded in this respect as retrofitting an existing installation. In particular, in the case of an existing installation, it is preferred that the sensor units in step B) are mounted onto the components of the installation, for example, by virtue of the sensor units being connected in a mechanically fixed manner to the component, for example by virtue of them being adhesively bonded to a surface of the components. In this case, it is also preferred, in particular, that the sensor units are of autonomous design. Step B) can thus be performed without extensive intervention in the installation.

As a further aspect, a data network is presented, which comprises at least one data set for use in one of the described methods.

As a further aspect, a control unit is presented, which is intended and configured to perform all the steps of the method for monitoring the installation.

As a further aspect, an installation having a plurality of components and a plurality of sensor units is presented, which can be used to detect a plurality of measurement variables, which are respectively associated with at least one of the components of the installation. The installation also comprises at least one control unit designed as described.

As a further aspect, a computer program is presented, which is intended and configured to perform all the steps of the described method for monitoring the installation.

As a further aspect, a machine-readable storage medium is presented, on which the described computer method is stored.

The particular advantages and refinement features described for the two methods can be applied and transferred to the data network, the control unit, the installation, the computer program and the machine-readable storage medium.

The disclosure and the technical milieu are explained in greater detail below with reference to the figures. The figures show one exemplary embodiment, although the disclosure is not restricted thereto. For clarification it should be pointed out that the technical features illustrated in the figures can also be combined with features of other figures and/or the description, without other technical features of a figure needing to be adopted. If there is a technical necessity to combine manifestations of one technical feature with those of another, reference is made or attention is drawn explicitly to this, such that otherwise there is a free combinability of these features.

### BRIEF DESCRIPTION OF THE DRAWINGS

In the figures, schematically:

FIG. 1: shows a first schematic illustration of a method for monitoring an installation,

FIG. 2: shows a second schematic illustration of a part of the method from FIG. 1,

FIG. 3: shows a third schematic illustration of a part of the method from FIGS. 1 and 2,

FIG. 4: shows a schematic illustration of a method for configuring and monitoring an installation using the method from FIGS. 1 to 3,

FIG. 5: shows a schematic illustration of an installation, which is configured by way of the method from FIG. 4 for monitoring according to the method from FIGS. 1 to 3.

### DETAILED DESCRIPTION

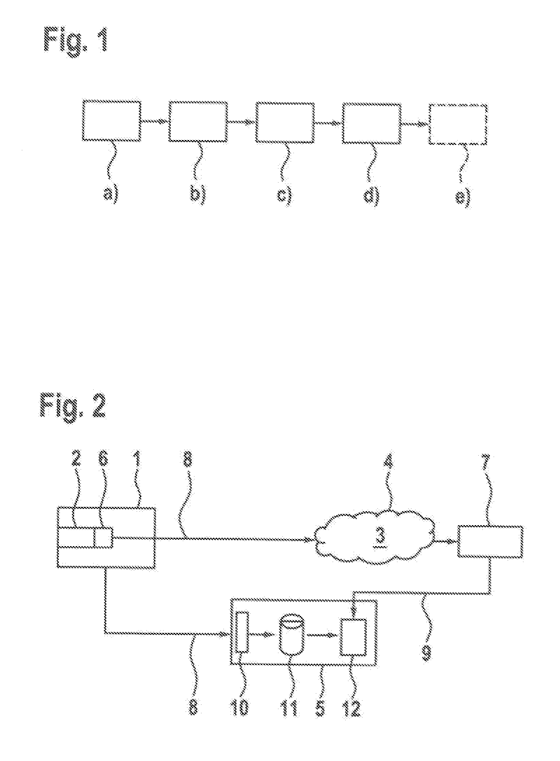

FIG. 1 shows a first schematic illustration of a method for monitoring an installation 1 shown in FIG. 2. FIG. 1 is described using the reference signs from FIG. 2. The installation 1 comprises a component 2.

The method for monitoring the installation 1 comprises the following steps:

a) providing a data set 3, which comprises a plurality of possible installation types 9,
b) detecting a plurality of measurement variables 8, wherein each of the measurement variables 8 is respectively associated with at least one of the components 2 of the installation 1,
c) determining the installation type 9 of the monitored installation 1 by comparing the measurement variables 8 detected according to step b) with the plurality of possible installation types 9 in the data set 3 provided according to step a), and
d) determining a state of at least one of the components 2 of the installation 1 depending on the measurement variables 8 detected according to step b) and the installation type 9 determined according to step c).

The method also optionally comprises a step e): adjusting at least one operating parameter of the installation 1 depending on the state determined according to step d).

FIG. 2 shows the monitoring of an installation 1 with an unknown installation type 9 according to steps b) to d) or e). To this end, an installation 1 having a component 2 is shown, with which component a sensor unit 6 is associated. A plurality of measurement variables 8 is transmitted from the sensor unit 6 to a data network 4. A data set 3 is stored in the data network 4, the plurality of measurement variables 8 being compared with said data set. Subsequently, in the box with reference sign 7, an association with an installation type 9, which is transmitted to a control unit 5, is carried out. In addition, the plurality of measurement variables 8 is transmitted to the control unit 5 and received there by a measurement variable interface 10. The measurement variable interface 10 is connected to a processor 12 by means of a database 11. The processor 12 thus has access to the measurement variables 8 and also access to the installation type 9.

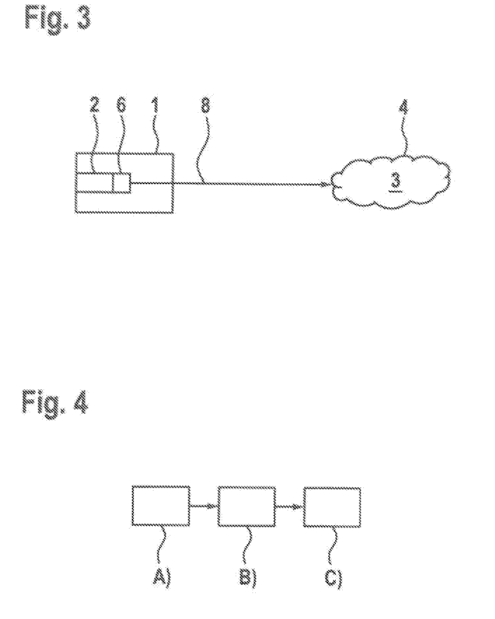

FIG. 3 shows how the data set 3 in step a) can be provided. To this end, an installation 1 with a known installation type 9 is shown. The measurement variables 8 are transmitted from the sensor unit 6 associated with the component 2 of the installation 1 to the data network 4. The data set 3 is therefore compiled there.

FIG. 4 shows a schematic illustration of a method for configuring and monitoring an installation using the method from FIGS. 1 to 3. FIG. 4 is described using the reference signs from FIGS. 2 and 3.

A method for configuring and monitoring an installation 1 comprises the following method steps:

A) providing the installation 1,
B) attaching a plurality of sensor units 6 to the installation 1, wherein at least one respective measurement variable 8 can be detected using the sensor units 6,
C) monitoring the installation 1 using a method, as described herein, using the sensor units 6 attached according to step B).

Step C) of the described method takes place as shown in FIGS. 1 and 2.

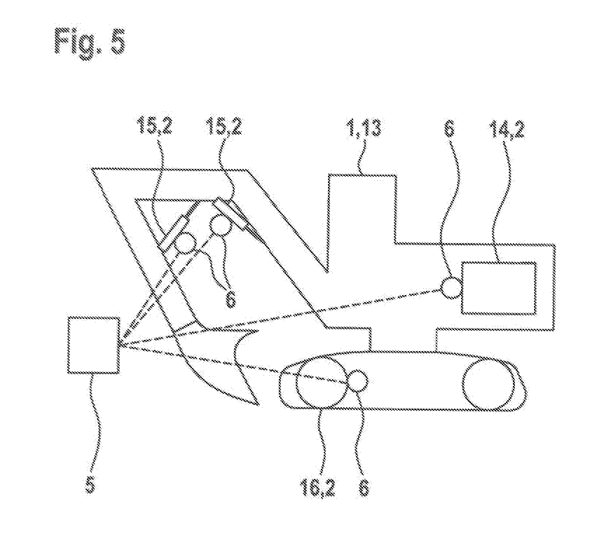

FIG. 5 shows a schematic illustration of an installation 1, which is configured by way of the method from FIG. 4 for monitoring according to the method from FIGS. 1 to 3. The installation 1 shown is a work machine 13. The work machine has a motor 14, two hydraulic elements 15 and a chain drive 16 as components 2. Each of the components 2 is assigned a respective sensor unit 6, which is connected to a control unit 5 via radio.

### LIST OF REFERENCE SIGNS

1 Installation
2 Component
3 Data set
4 Data network
5 Control unit
6 Sensor unit
7 Association with installation type
8 Measurement variable
9 Installation type
10 Measurement variable interface
11 Database
12 Processor
13 Work machine
14 Motor
15 Hydraulic unit
16 Chain drive

What is claimed is:

1. A method for monitoring an installation having at least one component, comprising:
detecting a plurality of measurement variables, each of the measurement variables is respectively associated with at least one of the components of the installation;
determining an installation type of the monitored installation by comparing the detected measurement variables with a plurality of possible installation types in a data set; and
determining a state of at least one of the components of the installation based on the detected measurement variables and the determined installation type.

2. The method according to claim 1, wherein detecting the plurality of measurement variables further comprises:
detecting at least one superordinate measurement variable associated overall with at least one part of the installation.

3. The method according to claim 1, wherein determining the installation type further comprises:
determining and comparing correlations between the detected plurality of measurement variables and correlations of measurement variables stored in the data set for various installation types.

4. The method according to claim 1, wherein the data set includes a neural network by way of learning in such a way that values of the measurement variables to be detected for the plurality of possible installation types contained in the data set are processed using the neural network.

5. The method according to claim 4, further comprising:
obtaining the values processed by the neural network by measuring the corresponding measurement variables at a plurality of possible installations with known installation types that are to be monitored.

6. The method according to claim 1, wherein determining the state of at least one of the components of the installation further comprises:
determining at least one state of wear of the respective component of the installation.

7. The method according to claim 1, further comprising:
adjusting at least one operating parameter of the installation based on the determined state.

8. The method according to claim 1, further comprising:
attaching a plurality of sensor units to the installation; and
detecting the plurality of measurement variables with the attached plurality of sensor units.

9. The method according to claim 1, wherein a data network includes at least one data set for use in the method.

10. The method according to claim 1, wherein a control unit is configured to perform the method.

11. The method according to claim 1, wherein a computer program is configured to perform the method.

12. The method according to claim 11, wherein the computer program is stored on a machine-readable storage medium.

13. An installation, comprising:
a plurality of components;
a plurality of sensor units configured to detect a plurality of measurement variables, which are respectively associated with at least one component of the plurality of components; and
at least one control unit configured to monitor the installation by
determining an installation type of the installation by comparing detected measurement variables with a plurality of possible installation types in a data set, and
determining a state of at least one component of the plurality of components based on the detected measurement variables and the determined installation type.
